(19) United States
(12) Patent Application Publication
(10) Pub. No.: US 2016/0348862 A1
(43) Pub. Date: Dec. 1, 2016

(54) LED CEILING LAMP

(71) Applicant: Unilumin Group Co., Ltd., Shenzhen (CN)

(72) Inventors: Youqing LIANG, Shenzhen (CN); Zheng XIAO, Shenzhen (CN); Mingfeng LIN, Shenzhen (CN)

(73) Assignee: Unilumin Group Co., Ltd., Shenzhen (CN)

(21) Appl. No.: 14/747,629

(22) Filed: Jun. 23, 2015

(30) Foreign Application Priority Data
May 29, 2015 (CN) 201520367389.3

(51) Int. Cl. F21S 8/04; F21V 1/00; F21V 17/10; F21V 19/00; F21V 23/06; F21V 21/03; F21V 5/00

(52) U.S. Cl. CPC F21S 8/046; F21V 21/03; F21V 1/00; F21V 5/007; F21V 19/004; F21V 23/06; F21V 17/10; F21Y 2105/001

(57) ABSTRACT

Disclosed is an LED ceiling lamp, comprising a base, a lampshade, an LED assembly and a protective cover, wherein the lampshade is permanently connected with the base to form an enclosed space where the LED assembly and the protective cover are accommodated; the LED assembly includes a lamp panel and several LED lamp beads arranged on the lamp panel, and the side of the lamp panel away from the LED lamp beads is fixed on the base; the protective cover includes a cover body, arranged on the lamp panel and connected with the base, and several lenses arranged in the cover body with one lens shade on each LED lamp bead. For the LED ceiling lamp above, refraction of the light from the LED lamp beads by the lens shades provides better light distribution and uniform luminance, making the light more uniform and softer and producing fewer dark regions.

### CROSS-REFERENCE TO RELATED APPLICATIONS

This application claims the benefit of priority to Chinese Application No. 201520367389.3, filed May 29, 2015, in the State Intellectual Property Office of the People's Republic of China. The disclosure of the document named above is incorporated herein by reference.

### BACKGROUND OF THE INVENTION

1. Field of the Invention

The present utility model relates to the LED lighting field, and more specifically to an LED ceiling lamp.

2. Description of the Related Art

Ceiling lamps are a type of light fixture installed on the ceiling inside a room or a corridor and in close proximity to its ceiling with the bottom surface fully affixed to the roof during installation. Ceiling lamps, featuring concise structure and quick installation, are broadly applied in corridors, bedrooms, toilets and other places of homes and office sites, hospitals, schools, and hotels. The light sources of the ceiling lamps in the prior art include general incandescent bulbs, fluorescent lights and LED lights, etc. In particular, LED lights are widely used in ceiling lamps due to the advantages such as reduced cost, excellent light effect, low energy consumption, and long service life.

However, a majority of ceiling lamps currently realize luminance uniformity by relying on the front giving light through the LED lamp beads arranged on the lamp panel in the shape of a circle or a matrix. LED lamp beads generally send out light at a lighting angle of 120°. Because dark regions may be formed as a result of the relative arrangement relation of LED lamp beads on the lamp panel or blocking and absorption of other structures, a series of problems may appear, for example: weakened lighting effect, nonuniform luminescence, and less attractive look.

### SUMMARY OF THE INVENTION

Therefore, based on the problems above, it is necessary to provide an LED ceiling lamp which can solve the technical problems such as how to let LED ceiling lamps realize high luminance uniformity, how to reduce the formation of dark regions, and how to simplify the structure of LED ceiling lamps. Moreover, the present utility model can also solve the problems of how to realize automatic assembly of LED ceiling lamps and how to improve the heat dissipation effect of LED ceiling lamps, etc.

An LED ceiling lamp, comprising: a base; a lampshade, permanently connected with the base to form an enclosed space; an LED assembly, accommodated in the enclosed space formed by the lampshade and the base, including a lamp panel and several LED lamp beads, wherein the side of the lamp panel away from the LED lamp beads is fixed on the base; a protective cover, including a cover body and several lenses arranged in the cover body, wherein the cover body is arranged on the lamp panel and connected with the base, and lens shades are arranged onto the LED beads with each lens corresponding to one LED lamp bead.

In one of the embodiments, openings are made along the edge of the lamp panel, hold-down blocks for matching the openings are arranged on the base, and the lamp panel is affixed to the base through the openings and the hold-down blocks.

In one of the embodiments, several protruding cylinders are arranged on the cover body of the protective cover, several sticking holes are made on the corresponding positions of the base, and the protruding cylinders are fixed in the sticking holes.

In one of the embodiments, the lens is made with a concave cavity in which at least part of an LED lamp bead is accommodated.

In one of the embodiments, a terminal is also included, the output of which is electrically connected with the lamp panel and the input is intended for electrical connection with the external power supply.

In one of the embodiments, a through-hole is made in the lamp panel so that the terminal is inserted through the through-hole and fixed to the lamp panel.

In one of the embodiments, the lamp panel is round in shape.

In one of the embodiments, several LED lamp beads are evenly distributed along the perimeter of the lamp panel.

In one of the embodiments, the cover body and the lens are integrally formed.

For the LED ceiling lamp above, since the light from the LED lamp beads is refracted by the lens shades arranged on the LED lamp beads, better light distribution and uniform luminance can be achieved, making the light more uniform and softer and producing fewer dark regions.

Moreover, since the lamp panel is affixed to the base though the hold-down blocks and the openings and the protective cover are fixed to the base though the sticking holes and the protruding cylinders, this makes the installation of the LED ceiling lamp simple and free from screws so as to realize an automatic assembly process, substantially raising the assembly efficiency of LED ceiling lamps.

In addition, the heat generated by the LED assembly can be effectively dissipated to the outside through the base by affixing the lamp panel on the base; besides, no heat sink is required, reducing the complexity of the structure and the production cost of LED ceiling lamps and providing a more attractive look.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a schematic structural view of the LED ceiling lamp according to one embodiment of the present utility model;

FIG. 2 shows a schematic exploded view of the LED ceiling lamp in FIG. 1;

FIG. 3 shows a schematic structural view of the protective cover of the LED ceiling lamp in FIG. 1;

FIG. 4 shows a cross-sectional view of the protective cover along the A-A in FIG. 3;

FIG. 5 shows a schematic drawing of the radiation effect of the LED lamp beads in the LED ceiling lamp according to one embodiment of the present utility model;

FIG. 6 shows a schematic structural view of the matching of the terminal and the LED assembly according to one embodiment of the present utility model.

### DETAILED DESCRIPTION OF THE EMBODIMENTS

The embodiments of the present utility model will be detailed hereinafter with the accompanying figures to make the aims, features, and advantages of the present utility model above more apparent. Many details are given in the following description for full understanding of the present utility model. However, the present utility model can be implemented by embodiments other than what is described herein. Those skilled in the field can make similar modifications without departing from the connotation of the present utility model. Therefore, the present utility model is not subject to the limitation of the embodiments disclosed below.

It is important to explain that when an element is described to be “fixed” to another element, it can be directly on another element or there can be one centered element. When one element is described as being “connected” with another element, it can be directly connected with another element or there can be a centered element. Expressions of the nomenclature such as “Vertical”, “Horizontal”, “Left” and “Right” used herein are only for description and do not indicate a unique embodiment.

Unless otherwise defined, all technical and scientific terms used herein have the same meaning with what those skilled in the technical field of the present utility model generally accepted. The terms used herein for the specification of the present utility model are only for describing the embodiments, but not intended to limit the present utility model. The term “and/or” used herein includes any and all combinations of one or more relevant items listed.

The present utility model provides an LED ceiling lamp, comprising: a base, a lampshade, an LED assembly and a protective cover, wherein the lampshade is permanently connected with the base to form an enclosed space, the LED assembly and the protective cover are accommodated in the enclosed space formed by the lampshade and the base; the LED assembly includes a lamp panel and several LED lamp beads arranged on the lamp panel, and the side of the lamp panel away from the LED lamp beads is fixed on the base; the protective cover includes a cover body and several lenses arranged in the cover body, wherein the cover body is arranged on the lamp panel and connected with the base, and lens shades are arranged onto the LED beads with each lens corresponding to one LED lamp bead.

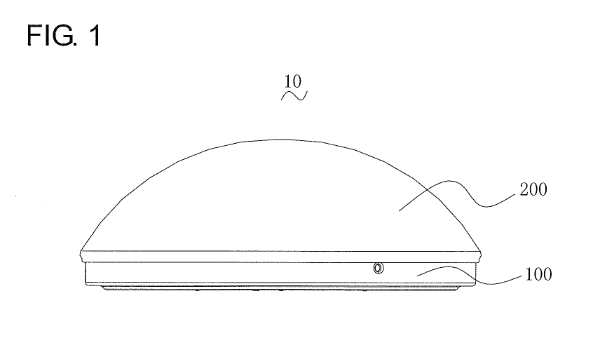

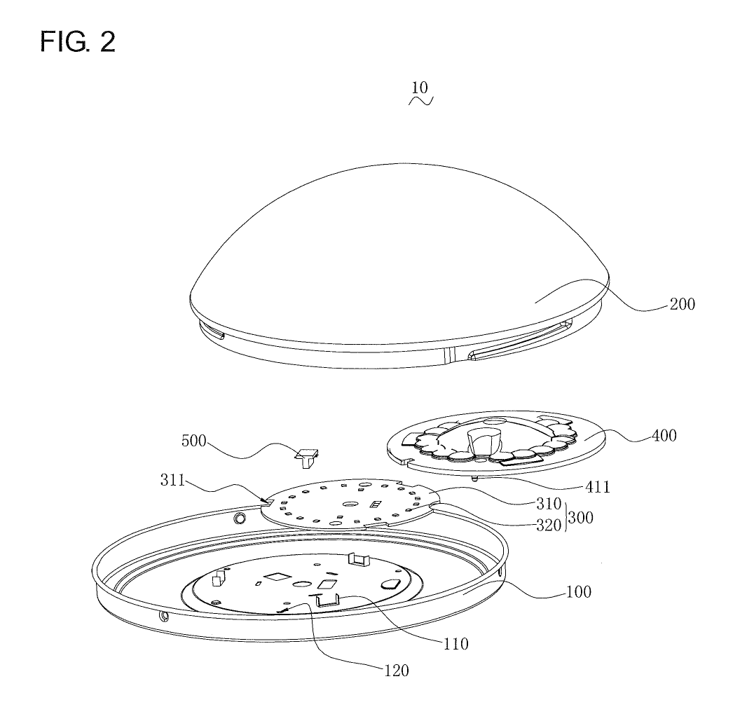

FIGS. 1 and 2 show a schematic structural drawing and an exploded view of the LED ceiling lamp. The ceiling lamp 10 comprises a base 100, a lampshade 200, an LED assembly 300, a protective cover 400 and a terminal 500. The lampshade 200 is permanently connected with the base 100 to form an enclosed space; the LED assembly 300, the protective cover 400 and the terminal 500 are accommodated in the enclosed space formed by the lampshade 200 and the base 100.

With reference to FIG. 2, the LED assembly 300 includes a lamp panel 310 and several LED lamp beads 320 arranged on the lamp panel 310, and the side of the lamp panel 310 away from the LED lamp beads 320 is fixed on the base 100. To improve the heat dissipation of LED ceiling lamps, for example, by affixing the lamp panel 310 on the base 100, the heat generated by the LED assembly can be effectively dissipated to the outside through the base; besides, no heat sink is required, reducing the complexity of the structure and the production cost of LED ceiling lamps and providing a more attractive look. To improve heat dissipation, in one embodiment, the base 100 is made of heat-conducting metal, for example, the base 100 is made of aluminum, copper, iron, or an alloy; or the base can be a round aluminum alloy plate with several air vents; thus better heat dissipation can be obtained, allowing the heat generated by the LED assembly to be dissipated to the outside through the base in time.

Furthermore, openings 311 are made along the edge of the lamp panel 310, hold-down blocks 110 for matching the openings 311 are arranged on the base 100, the lamp panel 310 is attached to the base 100 by means of the hold-down blocks 110 together with the openings 311 and the lamp panel 310 is fixed to the base 100 by press-fitting the hold-down blocks 110 into the openings 311 of the lamp panels 310, thus making the installation simple and free from screws and welding so as to realize an automatic assembly process, and substantially raising the assembly efficiency of LED ceiling lamps. For example, the end of the hold-down block 110 away from the base 100 is made with a raised mounting position for stopping the lamp panel 310 from escaping after press-fitting into the opening 311. In this way, more stable installation can be achieved and the LED lamp is easy to dismount and maintain.

In this embodiment, the lamp panel 310 is round in shape and the LED lamp beads 320 are evenly distributed along the perimeter of the lamp panel 310 which can avoid a series of problems caused by dark regions formed as a result of the mutual blocking and absorption of adjacent LED lamp beads, such as weakened lighting effect and nonuniform luminescence, and obtain more uniform luminance and better lighting effect.

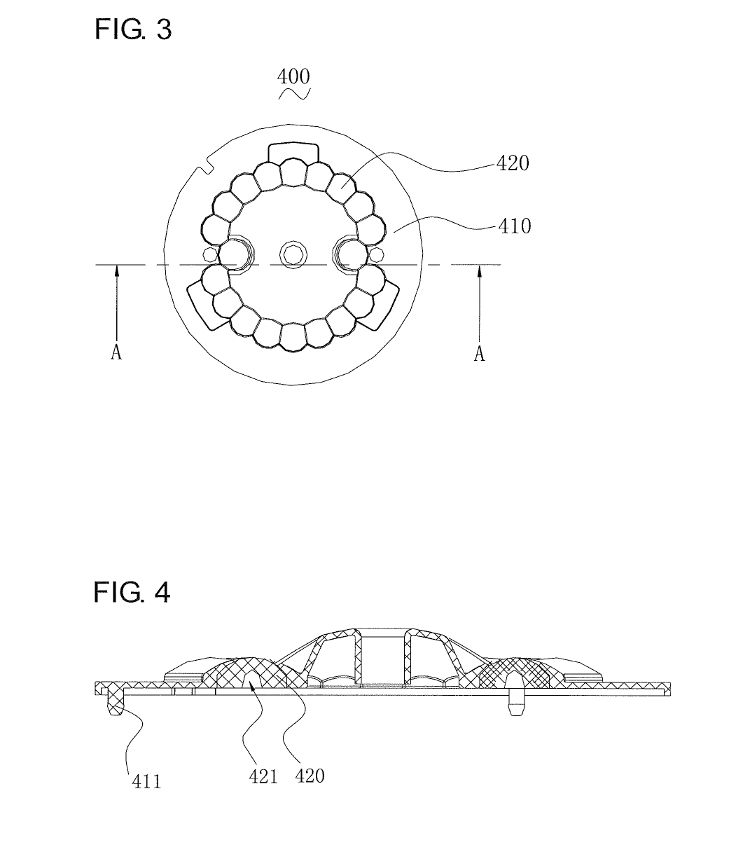

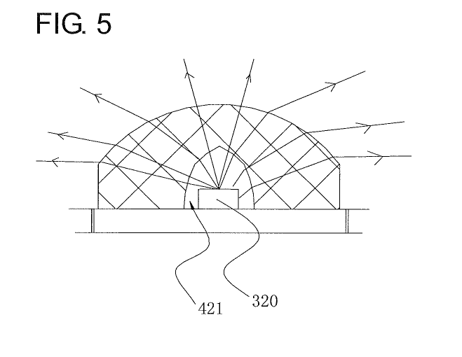

With reference to FIGS. 2 and 3, the protective cover 400 includes a cover body 410 and several lenses 420 arranged in the cover body 410, wherein the cover body 410 is arranged on the lamp panel 310 and connected with the base 100, and lens shades 420 are arranged onto the LED beads 320 with each lens 420 corresponding to one LED lamp bead 320. Specifically, with reference to FIG. 4, a concave cavity 421 is made in the lens 420 in which at least part of an LED lamp bead 320 is accommodated; since the light from the LED lamp beads 320 is refracted by the lens 420, better light distribution and uniform luminance can be achieved, making the light more uniform and softer and producing fewer dark regions.

To facilitate the production and processing of the protective cover as well as the assembly process, for example, the protective cover 400 is integrally formed, i.e. the cover body 410 and the lens 420 are formed into a whole, which can facilitate the production and processing of the protective cover and allow multiple lens to be mounted at the same time, featuring a simple assembly process.

Furthermore, several protruding cylinders 411 are arranged on the cover body 410 of the protective cover 400, several sticking holes 120 are made on the corresponding positions of the base 100, and each protruding cylinder 411 are fixed in the corresponding sticking hole 120, making mounting and dismounting simple and contributing to realize automatic assembly and raise the assembly efficiency of LED ceiling lamps.

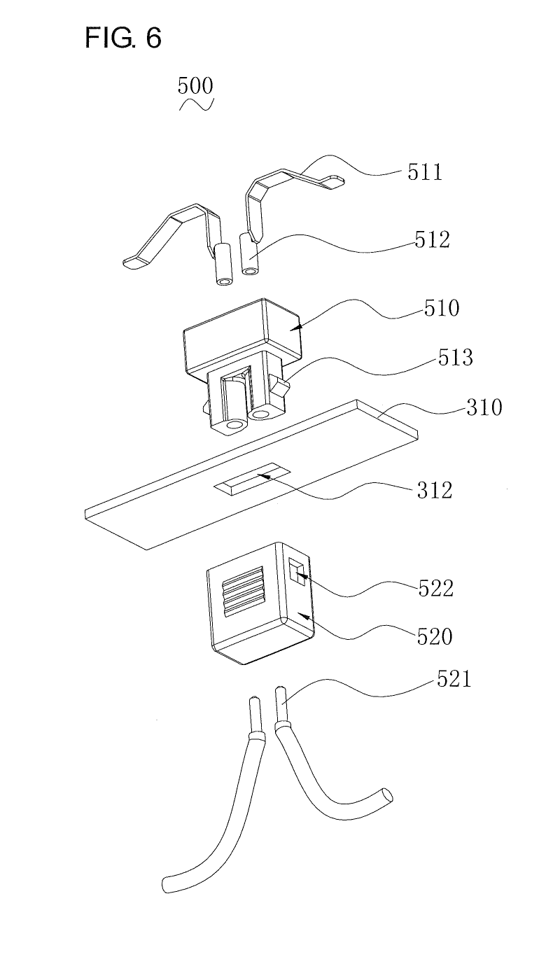

For example, the output of the terminal 500 is electrically connected with the lamp panel 310 and the input of the terminal 500 is intended for electrical connection with the external power supply. Specifically, with reference to FIG. 6, a through-hole 312 is made in the lamp panel 310 so that the terminal 500 is inserted through the through-hole 312 and fixed to the lamp panel 310.

In this embodiment, again with reference to FIG. 6, the terminal 500 includes the first terminal 510 and the second terminal 520, and the first terminal 510 is electrically connected with the lamp panel 310 and the second terminal 520 in turn. The first terminal 510 is provided with at least two contact pieces 511, plug pushes 512 and bumps 513. The second terminal 520 is provided with contact pins 521 and made with sticking holes 522, wherein the bumps 513 of the first terminal 510 are correspondingly inserted in the sticking holes 522 of the second terminal 520 and the contact pin 521 of the second terminal 520 are correspondingly inserted in the plug bushes 512 of the first terminal 510 to make electrical connection between the first terminal 510 and the second terminal 520, at least part of the first terminal 510 is inserted in the through-hole 312 and one end of each contact piece 511 is electrically connected with the lamp panel 310. Since the first terminal and the second terminal are permanently connected by inserting with the lamp panel held between the first terminal and the second terminal and the first terminal electrically connected with the lamp panel, the lamp has advantages of having a more compact structure, simpler installation, higher assembly efficiency, more reliable electrical connection, lower cost and suitability for large-scale industrial production than those in the prior art. In addition, the first terminal is arranged inside the LED ceiling lamp and the second terminal can be arranged outside the LED ceiling lamp. In practical use, the second terminal is connected with the mains supply, so users can supply power for the lamp panel and then for the LED lamp beads only by inserting the second terminal into the first terminal. Therefore, no power supply is required in the LED ceiling lamp, greatly reducing the size of the LED ceiling lamp.

For the LED ceiling lamp above, since the light from the LED lamp beads is refracted by the lens shades arranged on the LED lamp beads, better light distribution and uniform luminance can be achieved, making the light more uniform and softer and producing fewer dark regions.

Moreover, since the lamp panel is affixed to the base though the hold-down blocks and the openings and the protective cover is fixed to the base though the sticking holes and the protruding cylinders, this makes the installation of the LED ceiling lamp simple and free from screws so as to realize an automatic assembly process, substantially raising the assembly efficiency of LED ceiling lamps.

In addition, the heat generated by the LED assembly can be effectively dissipated to the outside through the base by affixing the lamp panel on the base; besides, no heat sink is, required, reducing the complexity of the structure and the production cost of LED ceiling lamps and providing a more attractive look.

The technical features in the embodiments above can be combined in any way. To make the description succinct, not all possible combinations of the technical features in the embodiments above are described. However, any combination of these technical features is deemed to fall into the scope recorded in the specification provided no contradiction exists.

The embodiments above, which are only several implements of the present utility model, are described in a detailed and specific way but shall not be interpreted to limit the scope of the present utility model. It shall be noted that it is apparent to those skilled in the field that several changes and modifications can be made without departing from the concept of the present utility model and these are within the protection scope of the present utility model. Therefore, the protection scope of the present utility model is subject to what is claimed in the claims.

What is claimed is:

1. An LED ceiling lamp, characterized in that, comprising:
a base;
a lampshade, permanently connected with the base to form an enclosed space;
an LED assembly, accommodated in the enclosed space formed by the lampshade and the base, including a lamp panel and several LED lamp beads, wherein the side of the lamp panel away from the LED lamp beads is fixed on the base;
a protective cover, including a cover body and several lenses arranged in the cover body, wherein the cover body is arranged on the lamp panel and connected with the base, and lens shades are arranged onto the LED beads with each lens corresponding to one LED lamp bead.

2. The LED ceiling lamp as claimed in claim 1, characterized in that openings are made along the edge of the lamp panel, hold-down blocks for matching the openings are arranged on the base, and the lamp panel is affixed to the base through the openings and the hold-down blocks.

3. The LED ceiling lamp as claimed in claim 1, characterized in that several protruding cylinders are arranged on the cover body of the protective cover, several sticking holes are made on the corresponding positions of the base, and the protruding cylinders are fixed in the sticking holes.

4. The LED ceiling lamp as claimed in claim 1, characterized in that the lens is made with a concave cavity in which at least part of an LED lamp bead is accommodated.

5. The LED ceiling lamp as claimed in claim 1, characterized in that a terminal is also included, the output of which is electrically connected with the lamp panel and the input is intended for electrical connection with the external power supply.

6. The LED ceiling lamp as claimed in claim 5, characterized in that a through-hole is made in the lamp panel so that the terminal is inserted through the through-hole and fixed to the lamp panel.

7. The LED ceiling lamp as claimed in claim 1, characterized in that the lamp panel is round in shape.

8. The LED ceiling lamp as claimed in claim 7, characterized in that several LED lamp beads are evenly distributed along the perimeter of the lamp panel.

9. The LED ceiling lamp as claimed in claim 1, characterized in that the cover body and the lens are integrally formed.
